(19) United States
(12) Patent Application Publication
(10) Pub. No.: US 2015/0065335 A1
(43) Pub. Date: Mar. 5, 2015

(54) LOWER-HYDROCARBON AROMATIZATION CATALYST AND METHOD FOR PRODUCING LOWER-HYDROCARBON AROMATIZATION CATALYST

(71) Applicant: MEIDENSHA CORPORATION, Tokyo (JP)

(72) Inventors: Hongtao Ma, Shinagawa-ku (JP); Yo Yamamoto, Numazu-shi (JP)

(73) Assignee: MEIDENSHA CORPORATION, Tokyo (JP)

(21) Appl. No.: 14/390,241

(22) PCT Filed: Feb. 28, 2013
(86) PCT No.: PCT/JP2013/055325

§ 371 Date: Oct. 2, 2014

(30) Foreign Application Priority Data
Apr. 3, 2012 (JP) 2012-084495

(51) Int. Cl. B01J 29/80; B01J 29/06

(52) U.S. Cl. CPC B01J 29/80; B01J 29/061; B01J 2029/062
USPC 502/67

(57) ABSTRACT

To contribute to the improvement of catalytic activity of a lower hydrocarbon aromatization catalyst, which converts a lower hydrocarbon(s) to an aromatic compound(s), and to the improvement of compactability of the catalyst.

The lower hydrocarbon aromatization catalyst is obtained by compacting a mixture obtained by mixing a metallosilicate supporting thereon a catalyst metal and having a large grain size with a metallosilicate supporting thereon a catalyst metal and having a small grain size. As the metallosilicate having a large grain size, one having a grain size of from 1.0 μm to 5.0 μm is used. As the metallosilicate having a small grain size, one having a grain size of from 0.1 μm to 1.0 μm is used. The percentage of the metallosilicate having a large grain size is adjusted to from 20% to 80%, relative to mass of the lower hydrocarbon aromatization catalyst.

### TECHNICAL FIELD

The present invention relates to a catalyst for converting lower hydrocarbon(s) to aromatic hydrocarbon(s). In particular, it relates to a high-degree use of natural gas, biogas and methane hydrate, in which methane is a main component.

### BACKGROUND TECHNIQUE

Natural gas, biogas, and methane hydrate are regarded as the most effective energy resources as global warming measures, and an interest in its use technique is increasing. Methane resource making use of its clean property attracts an attention as the next generation new organic resource and as a hydrogen resource for fuel cells.

As a process for producing hydrogen and aromatic hydrocarbons, such as benzene, from methane, one is known in which methane is reacted in the presence of a catalyst, such as Non-patent Publication 1. As the catalyst upon this, molybdenum supported on ZSM-5 is said to be effective (e.g., Patent Publication 1).

However, even in the case of using these catalysts, there are problems that carbon is deposited in large amounts and that conversion of methane is low.

In order to improve the above-mentioned conventional technique, a lower hydrocarbon (reaction gas) as the raw material gas of the aromatic hydrocarbon and a hydrogen-containing gas or hydrogen gas (regeneration gas) as a gas for maintaining the catalytic activity or regenerating the catalytic activity are switched periodically and alternately to make contact reactions with the catalyst (e.g., Patent Publication 2). In this way, the catalytic contact reactions are conducted by alternating the reaction gas and the regeneration gas to maintain the catalytic reaction while suppressing the deterioration over time of the catalyst.

Furthermore, there is proposed a technique to have both a high catalytic activity and a catalyst stability for a long period of time by defining the reaction temperature in the catalytic contact reactions (e.g., Patent Publication 3).

However, in order to make these catalysts endure the use for a long period of time, it is important to not only maintain chemical activity of the catalysts for a long period of time, but also maintain physical durability of the catalysts for a long period of time.

In general, in order to maintain physical durability of the catalysts, silicon oxide (SiO₂), aluminum oxide (Al₂O₃), etc. are used as inorganic binders. By making these inorganic binders exist in the catalysts, however, there has been a risk of the increase of factors to lower the function of the catalyst, such as the generation of by-products having no relation with the catalytic reaction, the occurrence of coking, etc.

In contrast with this, there is proposed a technique for compacting catalyst grains without adding an inorganic binder, resulting in the obtainment of certain catalytic activities (e.g., Patent Publication 4). In this method, due to easiness of compacting the catalyst, it has been a large advantageous effect in shortening the term necessary for the catalyst activity evaluation, which is important in the catalyst development. In the meantime, depending on the size of the particle diameter of a metallosilicate used as the catalyst, there has been a risk of difficulty of compacting the catalyst due to the weakness of sticking strength among metallosilicates.

As the metallosilicate for supporting the catalyst metal, from the viewpoint of the reaction efficiency of the catalyst, a metallosilicate is preferable that is superior in stability of a crystal structure having a micropore structure as a characteristic of metallosilicate and that is large in grain size to have many active spots effective in the reaction. However, the grain size of metallosilicate is enlarged, there is a risk that the compacting property becomes worse to break the compact during the use for a long period of time and to make it difficult to conduct a stable catalytic reaction. In contrast with this, if the grain size of metallosilicate is diminished, compacting property of metallosilicate is improved, but the catalytic activity in the initial stage of the reaction becomes lower as compared with a metallosilicate having a large grain size.

In view of the above situation, it is an object of the present invention to provide a technique to contribute to the improvement of the catalytic activity of a lower hydrocarbon aromatization catalyst for converting lower hydrocarbon(s) to aromatic compound(s) and the improvement of compacting property of this catalyst.

### PRIOR ART PUBLICATIONS

### Patent Publications

Patent Publication 1: Japanese Patent Application Publication Heisei 10-272366
Patent Publication 2: Japanese Patent Application Publication 2003-26613
Patent Publication 3: Japanese Patent Application Publication 2010-209057
Patent Publication 4: Japanese Patent Application Publication 2010-125342

### Non-Patent Publications

Non-patent Publication 1: JOURNAL OF CATALYSIS, 1997, Volume 165, p. 150-161

### SUMMARY OF THE INVENTION

A mode of the lower hydrocarbon aromatization catalyst of the present invention to achieve the above object is characterized by being formed by compacting a catalyst-supported, metallosilicate mixture of a first metallosilicate supporting thereon a catalyst metal and a second metallosilicate supporting thereon the catalyst metal and having a grain size smaller than that of the first metallosilicate.

Furthermore, another mode of the lower hydrocarbon aromatization catalyst of the present invention to achieve the above object is characterized by that, in the above lower hydrocarbon aromatization catalyst, the grain size of the second metallosilicate is one fifth or less of that of the first metallosilicate.

Furthermore, another mode of the lower hydrocarbon aromatization catalyst of the present invention to achieve the above object is characterized by that, in the above lower hydrocarbon aromatization catalyst, the grain size of the first metallosilicate is from 1.0 μm to 5.0 μm.

Furthermore, another mode of the lower hydrocarbon aromatization catalyst of the present invention to achieve the above object is characterized by that, in the above lower hydrocarbon aromatization catalyst, the grain size of the second metallosilicate is from 0.1 μm to 1.0 μm.

Furthermore, another mode of the lower hydrocarbon aromatization catalyst of the present invention to achieve the above object is characterized by that, in the above lower hydrocarbon aromatization catalyst, the second metallosilicate is added by from 20% to 80%, relative to mass of the mixture.

Furthermore, a mode of the process for producing the lower hydrocarbon aromatization catalyst of the present invention to achieve the above object is a process for producing the lower hydrocarbon aromatization catalyst for converting lower hydrocarbon(s) to aromatic compound(s) and is characterized by that a first metallosilicate, on which a catalyst metal is to be supported, and a second metallosilicate having a grain size smaller than that of the first metallosilicate are mixed together, the metal catalyst is supported on a mixture obtained by the mixing, and this catalyst metal supported mixture is compacted.

Furthermore, another mode of the process for producing the lower hydrocarbon aromatization catalyst of the present invention to achieve the above object is a process for producing the lower hydrocarbon aromatization catalyst for converting lower hydrocarbon(s) to aromatic compound(s) and is characterized by that a catalyst metal is supported on a first metallosilicate, the catalyst metal is supported on a second metallosilicate having a grain size smaller than that of the first metallosilicate, the first and second metallosilicates, on which the catalyst metal is supported, are mixed together, and a mixture obtained by the mixing is compacted.

### BRIEF DESCRIPTION OF THE DRAWINGS

FIG. 1 is a schematic view of a reaction apparatus used in a catalytic activity evaluation of the lower hydrocarbon aromatization catalyst according to an embodiment of the present invention.

FIG. 2 is a characteristic graph showing the variation of the catalytic activity relative to the reaction time of the lower hydrocarbon aromatization catalysts according to examples of the present invention.

FIG. 3 is a characteristic graph showing the variation of the catalytic activity relative to the reaction time of the lower hydrocarbon aromatization catalysts according to comparative examples.

### MODE FOR IMPLEMENTING THE INVENTION

The present invention is an invention relating to a lower hydrocarbon aromatization catalyst (hereinafter abbreviated as “catalyst”) for converting lower hydrocarbon(s) to aromatic hydrocarbons, which contains benzene and naphthalenes as main components, and a high-purity hydrogen gas, and relating to a process for producing this catalyst.

As the catalyst according to an embodiment of the present invention, it is possible to mention, for example, a mode in which a catalyst metal is supported on a metallosilicate.

As the metallosilicate having a catalyst metal supported thereon, for example, in the case of aluminosilicate, it is possible to cite molecular sieve 5A, faujasite (NaY and NaX), ZSM-5 and MCM-22, which are porous materials formed of silica and alumina. Furthermore, it can be exemplified by zeolite supports, which are porous materials having phosphoric acid as a main component and are characterized by having 6-13 angstrom micropores and channels, such as ALPO-5 and VPI-5. Furthermore, it can be exemplified by meso-porous supports, which contain silica as a main component and partly alumina as a component and are characterized by cylindrical micropores (channels) of meso-micropores (10-1000 angstroms), such as FSM-16 and MCM-41. Furthermore, besides the aluminosilicate, it is also possible to use a metallosilicate formed of silica and titania, etc. as the catalyst.

Furthermore, it is desirable that a metallosilicate used in the present invention has a surface area of 200-1000 m²/g and that its micro- and meso-pores are within a range of 5-100 angstroms. Furthermore, in case that the metallosilicate is, for example, aluminosilicate, it is possible to use one in which the ratio of silica content to alumina content (silica/alumina) is 1-8000, similar to porous materials that are generally available. It is, however, more preferable to make silica/alumina within a range of 10-100 in order to conduct an aromatization reaction of a lower hydrocarbon of the present invention with a practical lower hydrocarbon conversion and a selectivity to an aromatic hydrocarbon.

As the metallosilicate, it is general to use a proton-exchanged type (H type). Furthermore, the proton may be partly exchanged for at least one cation selected from alkali metals such as Na, K and Li, alkali-earth elements such as Mg, Ca and Sr, and transition metal elements such as Fe, Co, Ni, Zn, Ru, Pd, Pt, Zr and Ti. Furthermore, the metallosilicate may contain a suitable amount of Ti, Zr, Hf, Cr, Mo, W, Th, Cu, Ag, etc.

Then, it is preferable to use molybdenum as the catalyst metal, but it is also possible to use rhenium, tungsten, iron, and cobalt. A combination of these catalyst metals may be supported on the metallosilicate. Furthermore, besides these catalyst metals, at least one element selected from alkali-earth elements, such as Mg, or transition metal elements, such as Ni, Zn, Ru, Pd, Pt, Zr and Ti, may be supported on the metallosilicate.

In the case of supporting the catalyst metal (a precursor containing the same) on a metallosilicate, it is conducted to have a percentage of the catalyst metal to mass of the support of a range of 0.001-50%, preferably 0.01-40%. Furthermore, as a method of supporting on the metallosilicate, there is a method in which a supporting is conducted on a metallosilicate support by impregnation or an ion exchange method from a catalyst metal precursor aqueous solution or solution of an organic solvent such as alcohol, and then a heating treatment is conducted under an atmosphere of an inert gas or oxygen gas. For example, as examples of a precursor containing molybdenum as one of the catalyst metals, it is possible to cite halides such as chlorides and bromides, mineral acid salts such as nitrates, sulfates and phosphates, carboxylates such as carbonates, acetates and oxalates, etc. of molybdenum, besides ammonium paramolybdate, ammonium phosphomolybdate, 12-series molybdic acids.

Herein, a process of supporting the catalyst metal on a metallosilicate is explained by showing as an example a case of using molybdenum as the catalyst metal. Firstly, an impregnation supporting of an ammonium molybdate aqueous solution is conducted on a metallosilicate support. Then, the supported substance is dried under reduced pressure to remove the solvent, and then a heating treatment is conducted at a temperature of 250-800° C. (preferably 350-600° C.) in a nitrogen-containing oxygen stream or a pure oxygen stream. The thus obtained metallosilicate supporting thereon the catalyst metal is compacted into a shape such as that of pellets. The compacting pressure is normally 100 to 400 kgf/cm².

Furthermore, in the present invention, lower hydrocarbons mean methane and C₂₋₆ saturated or unsaturated hydrocarbons. As examples of these C₂₋₆ saturated or unsaturated hydrocarbons, it is possible to mention ethane, ethylene, propane, propylene, n-butane, isobutane, n-butene, and isobutene, etc.

In the following, we conduct a more detailed explanation on the lower hydrocarbon aromatization catalyst and the lower hydrocarbon aromatization catalyst production process by showing specific examples of the lower hydrocarbon aromatization catalyst according to the present invention.

### Example 1

The catalyst was produced by using two kinds of metallosilicate shown in the following (1) and (2) different in grain size, as a metallosilicate support. In (1) and (2), the grain size of metallosilicate is expressed by the average grain size. This is because the grain size of metallosilicate contains an error by a certain degree. In general, since the grain sizes of most metallosilicates have values close to the average grain size, it is possible to consider the value of the average grain size as the grain size of metallosilicate. In the examples, in order to avoid the effect of aggregated grains, the average grain size was calculated by a random sampling of twenty grains under a microscope observation, then measuring the grain sizes in one direction, and then averaging them. The calculation method of the average grain size is not limited to this example, but it suffices to calculate the average grain size by a suitable, publicly known method.

(1) H-type, ZSM-5 zeolite (the average grain size=about 4 μm, SiO₂/Al₂O₃=25-70) (hereinafter, referred to as a first metallosilicate (ZSM5A))
(2) H-type, ZSM-5 zeolite (the average grain size=about 0.8 μm, SiO₂/Al₂O₃=25-70) (hereinafter, referred to as a second metallosilicate (ZSM5B))

Firstly, 25 parts by weight of the second metallosilicate was uniformly mixed with 75 parts by weight of the first metallosilicate to obtain a mixture. On the obtained mixture molybdenum was supported as the catalyst metal. Then, the molybdenum-supported mixture (hereafter referred to as the catalyst powder) was compacted to produce a catalyst of Example 1. Herein, the process for supporting the catalyst metal and the process for compacting the catalyst powder are explained in detail.

(Process for Supporting the Catalyst Metal)

An aqueous solution for impregnation was prepared by dissolving ammonium molybdate ((NH₄)₆Mo₇O₂₄) in water by 0.05 mol/L. To this aqueous solution for impregnation the mixture of the first metallosilicate and the second metallosilicate was added, followed by stirring, to impregnate the first metallosilicate and the second metallosilicate with molybdenum.

Then, the molybdenum-impregnated mixture was dried, followed by sintering at 550° C. for 8 hours to obtain a molybdenum-supported mixture (catalyst powder). The amount of molybdenum supported on this catalyst powder was 6 weight %, based on the total of the catalyst.

(Compacting Process)

The catalyst powder obtained by the above process for supporting the catalyst metal was compacted into a rod shape (φ 2.4 mm×L 5 mm) by using a vacuum extruder. The extrusion pressure upon this compacting was 100 kgf/cm².

### Example 2

The catalyst of Example 2 was produced by the same process as that for the catalyst of Example 1, except in that the mixing ratio of the second metallosilicate to the first metallosilicate was different.

Firstly, 50 parts by weight of the second metallosilicate was uniformly mixed with 50 parts by weight of the first metallosilicate to obtain a mixture. Then, on the obtained mixture, molybdenum was supported by the same process for supporting the catalyst metal as that of Example 1. Then, the catalyst powder obtained by supporting molybdenum was compacted by the same compacting process as that of Example 1 to produce the catalyst of Example 2. The amount of molybdenum supported on the catalyst of Example 2 was 6 weight %, based on the total of the catalyst.

### Example 3

The catalyst of Example 3 was produced by the same process as that for the catalyst of Example 1, except in that the mixing ratio of the second metallosilicate to the first metallosilicate was different.

Firstly, 75 parts by weight of the second metallosilicate was uniformly mixed with 25 parts by weight of the first metallosilicate to obtain a mixture. Then, on the obtained mixture, molybdenum was supported by the same process for supporting the catalyst metal as that of Example 1. Then, the catalyst powder obtained by supporting molybdenum was compacted by the same compacting process as that of Example 1 to produce the catalyst of Example 3. The amount of molybdenum supported on the catalyst of Example 3 was 6 weight based on the total of the catalyst.

### Comparative Example 1

As to the catalyst of Comparative Example 1, using the first metallosilicate, the catalyst was produced by the same process as that for the catalyst of Example 1. The first metallosilicate was compacted at an extrusion pressure of 400 kgf/cm², due to its large grain size.

Firstly, a catalyst powder having molybdenum supported on the first metallosilicate was obtained by the same process for supporting the catalyst metal as that of Example 1. The obtained catalyst powder was compacted by the same compacting process (extrusion pressure: 400 kgf/cm²) as that of Example 1 to produce the catalyst of Comparative Example 1. The amount of molybdenum supported on the catalyst of Comparative Example 1 was 6 weight %, based on the total of the catalyst.

### Comparative Example 2

As to the catalyst of Comparative Example 2, using the second metallosilicate, the catalyst was produced by the same process as that for the catalyst of Example 1.

Firstly, a catalyst powder having molybdenum supported on the second metallosilicate was obtained by the same process for supporting the catalyst metal as that of Example 1. The obtained catalyst powder was compacted by the same compacting process as that of Example 1 to produce the catalyst of Comparative Example 2. The amount of molybdenum supported on the catalyst of Comparative Example 2 was 6 weight %, based on the total of the catalyst.

### Comparative Example 3

The catalyst of Comparative Example 3 is one prepared by adding silicon oxide, which is generally used as an inorganic binder, to the catalyst of Comparative Example 1 and then compacting it.

Firstly, a catalyst powder having molybdenum supported on the first metallosilicate was obtained by the same process for supporting the catalyst metal as that of Example 1. To the obtained catalyst powder, silicon oxide was added, followed by compacting by the same compacting process as that of Example 1 to produce the catalyst of Comparative Example 3. The amount of molybdenum supported on the catalyst of Comparative Example 3 was 6 weight %, based on the total of the catalyst.

### Comparative Example 4

Comparative Example 4 refers to one prepared by compacting a silicon oxide powder by the same compacting process as that of Example 1.

(Evaluation of Catalyst Stability)

By adding pressure on the catalysts of Examples 1-3 and the catalysts of Comparative Examples 1 and 2, the pressure at which collapse of each catalyst started was measured. The value of the pressure, at which collapse of each catalyst (Examples 1-3 and Comparative Example 2) started, relative to the pressure, at which collapse of the catalyst of Comparative Example 1 started, was calculated as compaction strength. The calculated results of compaction strength are shown in Table 1.

TABLE 1

| Catalyst | strength after shaping into particles |
|---|---|
| Com. Ex. 1: ZSM5A | 1 |
| Example 1: 75ZSM5A - 25ZSM5B | 3 |
| Example 2: 50ZSM5A - 50ZSM5B | 4 |
| Example 3: 25ZSM5A - 75ZSM5B | 7 |
| Com. Ex. 2: ZSM5B | 10 |

As shown in Table 1, it is understood that the catalyst of Comparative Example 1 is the lowest in compaction strength and therefore easily collapses. As the proportion of the second metallosilicate relative to the total of the catalyst increases, compaction strength of the catalyst becomes higher. It is understood that compaction strength becomes highest in the catalyst (Comparative Example 2) consisting of only the second metallosilicate and that the catalyst of Comparative Example 2 is high in physical stability.

It was confirmed from the results of Table 1 that physical stability of the catalyst can be improved by increasing the amount of the second metallosilicate added, as compared with the catalyst (Comparative Example 1) consisting of only the first metallosilicate.

(Catalytic Activity Evaluation)

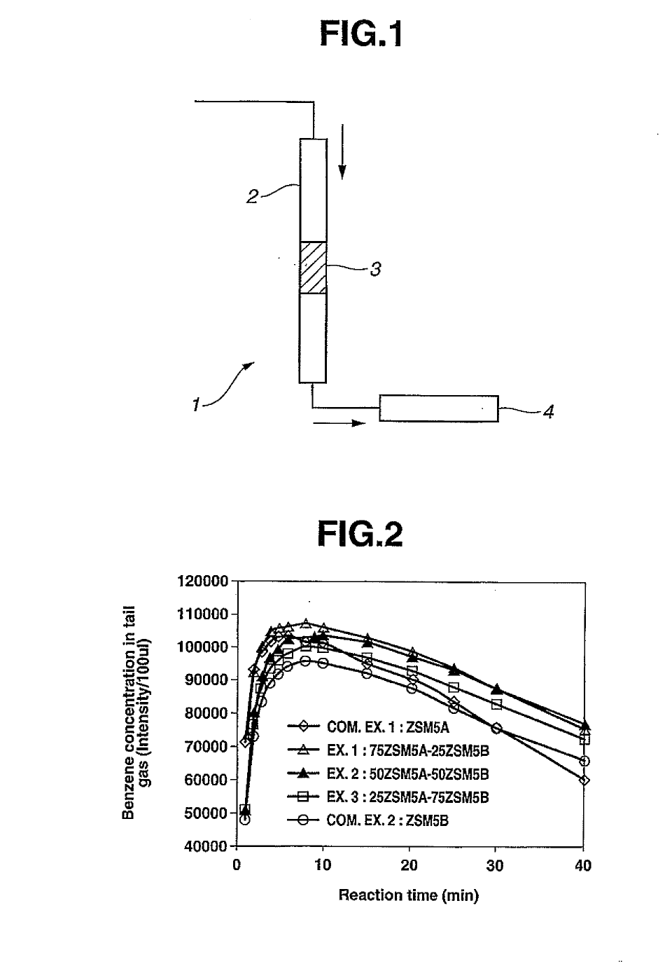

A quartz tube 2 (inner diameter: 18 mm) of a reaction apparatus 1 shown in FIG. 1 was charged with the catalysts of Examples 1-3 and the catalysts of Comparative Examples 1-4, and a catalytic reaction of methane was conducted on the catalyst 3 charged, to evaluate the catalytic activity of each catalyst 3. The reaction conditions for evaluating the catalyst activity are shown in the following.

(Reaction Conditions)

Raw material gas: 90 volume % of methane and 10 volume % of argon.
Reaction temperature: 800° C.
Raw material gas supply rate (space velocity per 1 g of the catalyst): 10000 ml/g/h.

Prior to conducting the catalytic reaction of the raw material gas with each catalyst, a pretreatment of the catalyst was conducted. In the pretreatment of the catalyst, the temperature of the catalyst was increased to 550° C. under an air stream, followed by maintaining it for 2 hours, then switching to a pretreatment gas of 20% methane and 80% hydrogen, increasing the temperature to 700° C., and then maintaining it for 1 hour. Then, it was switched to the raw material gas, followed by increasing the temperature until a predetermined temperature (800° C.) to conduct the evaluation of the catalyst. In the analysis of components in the gas after the reaction, hydrogen, argon and methane were analyzed by TCD-GC, and aromatic hydrocarbons, such as benzene, toluene, xylene, and naphthalene, were analyzed by FID-GC.

As to the evaluation of the catalytic activity, the evaluation was conducted by the concentration of benzene in 100 μl of the reaction gas after conducting the catalytic reaction with the catalyst.

(Measurement Results)

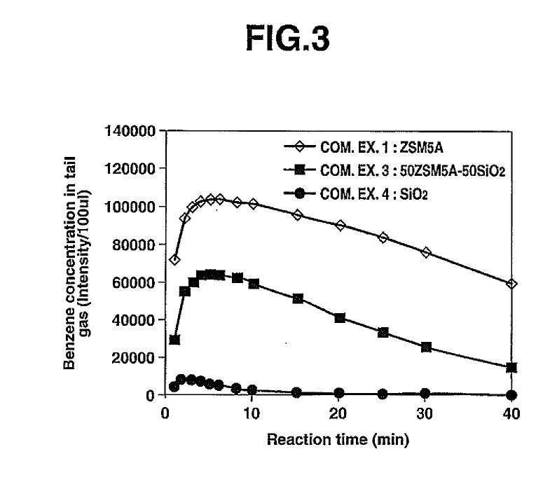

There is shown in FIG. 2 the change over time of the concentration of benzene in the reaction gas when conducting a catalytic reaction of the raw material gas (methane+argon) by using the catalysts of Examples 1-3 and the catalysts of Comparative Examples 1 and 2. Furthermore, there is shown in FIG. 3 the change over time of the concentration of benzene in the reaction gas when conducting a catalytic reaction of the raw material gas by using the catalysts of Comparative Examples 1, 3 and 4.

As is clear from FIG. 2, the catalyst of Example 1 had a catalytic activity higher than that of the catalyst of Comparative Example 1 over the whole reaction time from the start of the reaction to 40 minutes after the reaction. Furthermore, the catalyst of Example 2 has the highest activity among all of the catalysts over the reaction time of 30 minutes or longer and therefore is understood to have a superior catalyst stability. Although the catalysts of Examples 2 and 3 are lower than the catalyst of Comparative Example 1 in catalyst activity at the start of the reaction, it is understood that they have catalyst activities higher than that of the catalyst of Comparative Example 1 after 10 minutes from the start of the reaction.

In a comparison between the catalyst of Comparative Example 1 and the catalyst of Comparative Example 2, the catalyst of Comparative Example 1 shows a catalyst activity higher than that of the catalyst of Comparative Example 2 during 30 minutes from the start of the reaction. When the reaction time exceeds 30 minutes, the catalyst of Comparative Example 2 has a catalytic activity higher than that of the catalyst of Comparative Example 1. That is, it is understood that the first metallosilicate is higher in catalytic activity in the initial stage of the reaction and lower in stability of the catalytic activity, as compared with the second metallosilicate.

That is, a catalyst having a metallosilicate with a large grain size as the support is that the crystal structure of metallosilicate crystals is stable and that there are also many acid sites serving as the origins of the catalytic reaction. Therefore, it is considered that a temporary reaction activity becomes extremely high. However, in case that the grain size of metallosilicate is large, it is considered that, due to taking much time when the product produced by the reaction in the interior of the metallosilicate crystals diffuses toward the outside of the crystals, micropores possessed by the metallosilicate are clogged, and thereby a long-term stability of the catalyst reaction is gradually impaired.

In contrast with this, since a catalyst having a metallosilicate with a small grain size as the support is small in metallosilicate crystal size, it is considered that diffusion of the raw material gas in the crystals is easy, and the product produced by the catalytic reaction also diffuses rapidly towards the outside of the crystals. Therefore, it is considered that, as compared with the catalyst having a metallosilicate with a large grain size as the support, the catalyst having a metallosilicate with a small grain size as the support is that the catalytic activity in the initial stage of the reaction is inferior, but is superior in terms of a long-term stability of the catalytic activity.

In order to improve physical stability of the catalyst, an inorganic binder, such as silicon oxide, is used in prior art. If an inorganic binder is added, physical stability of the catalyst improves, but activity of the catalyst lowers. For example, as shown in FIG. 3, the catalyst (catalyst of Comparative Example 3) prepared by adding silicon oxide as an ordinary inorganic binder to the catalyst of Comparative Example 1 and compacting it is improved in physical stability of the catalyst, but becomes lower in catalytic activity than the catalyst of Comparative Example 1. This is considered to be due to the increase of factors for blocking the catalytic reaction of Comparative Example 1, such as the decrease of the surface area for conducting the catalytic reaction by adding silicon oxide, since silicon oxide (the catalyst of Comparative Example 4) does not have a catalytic activity for conducting a lower hydrocarbon aromatization reaction.

As mentioned above, according to the lower hydrocarbon aromatization catalyst of the present invention, not only physical stability of the catalyst that is obtained by compacting a metallosilicate with a catalyst metal supported thereon improves, but also it is possible to improve catalytic activity in the initial stage of the reaction of the lower hydrocarbon aromatization catalyst and improve the catalytic activity stability.

That is, when producing a catalyst by compacting a metallosilicate with a catalyst metal supported thereon, it is possible to improve physical stability of the metallosilicate by adding, as a binder, one having a catalyst metal supported on a metallosilicate having a grain size smaller than the grain size of this metallosilicate and then compacting it.

By producing a catalyst in this manner, not only physical stability of the catalyst improves, but also it is possible to obtain a catalyst having a higher catalytic activity and a higher catalyst stability, as compared with a catalyst obtained by compacting only a metallosilicate having a large grain size or a metallosilicate having a small grain size. That is, it is possible to obtain a catalyst having a higher catalytic activity and a higher catalytic activity stability due to a complementary and synergistic action between characteristics (a high catalytic activity in the initial stage of the reaction) of a metallosilicate having a large grain size and characteristics (a high catalytic activity stability and a high compactability) of a metallosilicate having a small grain size, as compared with a catalyst prepared by compacting only a metallosilicate having a large grain size or a metallosilicate having a small grain size.

Furthermore, according to the lower hydrocarbon aromatization catalyst production process of the present invention, it is possible to obtain a high strength, binderless, lower hydrocarbon aromatization catalyst having a high catalytic reaction activity and a high catalytic activity stability.

As above, in the explanation of the lower hydrocarbon aromatization catalyst and the process for producing the lower hydrocarbon aromatization catalyst of the present invention, only specific examples described have been explained in detail. It is obvious to a person skilled in the art that the present invention can variously be changed and modified within a scope of the technical idea of the present invention. Therefore, it is natural that modes after such change and modification also belong to the lower hydrocarbon aromatization catalyst and the process for producing the lower hydrocarbon aromatization catalyst of the present invention.

For example, in the lower hydrocarbon aromatization catalyst of the present invention, a combination of the metallosilicate and the catalyst metal is not limited to the embodiments, but it suffices to make a production by suitably combining a metallosilicate with a catalyst metal, which are publicly known. Furthermore, in the explanation of the embodiments, the metallosilicate having a large grain size and the metallosilicate having a small grain size are explained by mentioning examples using the same metallosilicate and the same catalyst metal, but it is not necessary to have the same combination.

Furthermore, in the examples, the catalyst metal is supported after mixing the first metallosilicate with the second metallosilicate. It is, however, optional to support the catalyst metal on each of the first metallosilicate and the second metallosilicate, then mix together the first metallosilicate and the second metallosilicate, on which the catalyst meal are supported, and then compact the obtained mixture.

Furthermore, a combination of a metallosilicate having a large grain size and a metallosilicate having a small grain size is not limited to the embodiments. It is possible to obtain an advantageous effect similar to that of the lower hydrocarbon aromatization catalyst, by suitably selecting and using a combination of a catalyst having a grain size capable of obtaining a high catalytic activity in the initial stage of the reaction and a catalyst having a grain size capable of obtaining a high catalyst stability. For example, it is possible to obtain an advantageous effect similar to that of the lower hydrocarbon aromatization catalyst of the present invention by mixing together a metallosilicate having a grain size capable of obtaining a high catalytic activity in the initial stage of the reaction and a metallosilicate having a grain size that is ⅕ or less of the grain size of this metallosilicate and then compacting it.

The range of the grain size of a metallosilicate available in general is about 0.1 μM to 5.0 μm. In order to synthesize a metallosilicate with a larger grain size, it is necessary to conduct the reaction for a long period of time under a stable temperature condition. In contrast with this, it is possible to relatively easily synthesize a metallosilicate with a smaller grain size. As the metallosilicate becomes smaller in grain size (for example, 0.1 μm or less in grain size), there occurs a risk of impairing crystallinity (homogeneity of the crystal structure) of metallosilicate. In particular, since zeolite represented by ZSM-5 has a long-period crystal structure, it becomes necessary to have a certain grain size (crystallite size) in order to stably maintain a certain crystal structure. Furthermore, it is possible to obtain a metallosilicate having a small grain size by pulverizing an existing metallosilicate. In this case, too, however, there is a risk that the crystal structure collapses in the step of pulverization to lower the catalytic activity of the catalyst obtained.

A metallosilicate with a large grain size (grain size is from 1.0 μm to 5.0 μM, more preferably from 4.0 μm to 5.0 μm) is high in catalytic activity in the initial stage of the reaction, due to many active sites that exist with the high crystallinity and are effective for the reaction. However, it is lower in a long term stability of the reaction, as compared with a metallosilicate with a small grain size. Thus, the catalytic activity lowers gradually with the passage of the catalytic reaction time. Furthermore, a metallosilicate with a large grain size (a metallosilicate with a grain size of; for example, 5.0 μm or greater) is low in compactability; in the case of compacting at a pressure of 400 kgf/cm², compacting into pellets is difficult in some cases. In contrast with this, a metallosilicate with a small grain size (a metallosilicate with a grain size of from 0.1 μm to 1.0 μm, more preferably a metallosilicate with a grain size of from 0.2 μm to 0.8 μm) is low in crystallinity and is lower in catalytic activity in the initial stage of the reaction, as compared with a metallosilicate with a Large grain size, but is superior in a long term stability of catalytic activity. A metallosilicate with a small grain size (a metallosilicate with a grain size of, for example, 1.0 μm or less) is superior in compactability and can easily be compacted by a pressure of 100 kgf/cm².

Therefore, in the lower hydrocarbon aromatization catalyst of the present invention, it is possible to obtain a metallosilicate (the first metallosilicate) having a high catalytic activity in the initial stage of the reaction by adjusting the grain size of metallosilicate to from 1.0 μm to 5.0 μm (more preferably, the grain size is from 4.0 to 5.0 μm). Furthermore, it is possible to obtain a metallosilicate (the second metallosilicate) that can easily be compacted and maintains crystallinity (homogeneity of the crystal structure) by adjusting the grain size of metallosilicate to from 0.1 μm to 1.0 μm (more preferably, the grain size is from 0.2 to 0.8 μm).

Furthermore, as to the mixing percentage of a metallosilicate with a large grain size and a metallosilicate with a small grain size, it has a higher catalytic activity in the initial stage of the reaction with a higher percentage of a metallosilicate with a large grain size, and shows a higher catalytic activity stability and a higher physical stability with a higher percentage of a metallosilicate with a small grain size. Therefore, it is possible to obtain a lower hydrocarbon aromatization catalyst having a high catalytic activity in the initial stage of the reaction, a high catalytic activity stability and a high physical stability by adjusting the percentage of a metallosilicate with a large grain size to 80-20%, more preferably 75-25%, more preferably 75-50%, relative to mass (except mass of the catalyst metal) of the lower hydrocarbon aromatization catalyst in whole.

### EXPLANATION OF SIGNS

1 . . . a reaction apparatus
2 . . . a quartz tube
3 . . . a catalyst (a lower hydrocarbon aromatization catalyst)
4 . . . a detector

1-7. (canceled)

8. A lower hydrocarbon aromatization catalyst characterized by being formed by compacting a catalyst-supported, metallosilicate mixture of a first metallosilicate having a catalyst metal supported on a metallosilicate having a Si/Al ratio of 10-100 and a second metallosilicate supporting thereon the catalyst metal, having a Si/Al ratio of 10-100, and having an average grain size smaller than that of the first metallosilicate.

9. The lower hydrocarbon aromatization catalyst according to claim 8, which is characterized by that the average grain size of the second metallosilicate is one fifth or less of that of the first metallosilicate.

10. The lower hydrocarbon aromatization catalyst according to claim 9, which is characterized by that the average grain size of the first metallosilicate is from 1.0 μm to 5.0 μm.

11. The lower hydrocarbon aromatization catalyst according to claim 9, which is characterized by that the average grain size of the second metallosilicate is from 0.1 μm to 1.0 μm.

12. The lower hydrocarbon aromatization catalyst according to claim 8, which is characterized by that the second metallosilicate is added by from 20% to 80%, relative to mass of the mixture.

13. A process for producing a lower hydrocarbon aromatization catalyst for converting a lower hydrocarbon to an aromatic compound and is characterized by
that a first metallosilicate having a Si/Al ratio of 10-100, on which a catalyst metal is to be supported, and a second metallosilicate having an average grain size smaller than that of the first metallosilicate and having a Si/Al ratio of 10-100 are mixed together,
that the metal catalyst is supported on a mixture obtained by the mixing, and
that this catalyst metal supported mixture is compacted.

14. A process for producing a lower hydrocarbon aromatization catalyst for converting a lower hydrocarbon to an aromatic compound and is characterized by
that a catalyst metal is supported on a first metallosilicate having a Si/Al ratio of 10-100,
that the catalyst metal is supported on a second metallosilicate having a Si/Al ratio of 10-100 and having an average grain size smaller than that of the first metallosilicate,
that the first and second metallosilicates, on which the catalyst metal is supported, are mixed together, and
that a mixture obtained by the mixing is compacted.
